(19) United States
(12) Patent Application Publication
(10) Pub. No.: US 2004/0174013 A1
(43) Pub. Date: Sep. 9, 2004

(54) Mailer adapted to automated letter opener

(76) Inventor: Michael C. Dyer, Trabuco Canyon, CA (US)

Correspondence Address: NIXON & VANDERHYE, PC, 1100 N GLEBE ROAD, 8TH FLOOR, ARLINGTON, VA, 22201-4714, US

(21) Appl. No.: 10/378,597

(22) Filed: Mar. 5, 2003

(51) Int. Cl. B42D 15/00

(52) U.S. Cl. 283/116

(57) ABSTRACT

A self-mailer construction that creates a single- or double-panel inside a carrier. Die-cuts are positioned in such as way as to reduce the size of at least one internal panel. Because these panel(s) are narrow-width, they terminate short of the full-width portion of the outside panels and, therefore, are unattached at any point other than the top edge of the sealed document. Accordingly, when the mailer is engaged with an envelope slitter or similar device, the truncated panel becomes free-floating and can be readily removed.

### BACKGROUND AND SUMMARY OF THE INVENTION

The present invention relates to a self-mailer construction and, more particularly, to a self-mailer construction that lends itself to being opened by means of automated letter openers.

While self-mailers have proven to be very popular medium for preparing both negotiable and non-negotiable documents for the mail stream, the intended recipient of these documents has been, traditionally, individual businesses or customers. As such, the normal opening method employed for these forms has been perfectly adequate. That is, an opening method that requires the recipient to manually remove strips, or margins, around the perimeter of the form. When opening an individual document, such as a payroll check, or notice, this opening method does not create any significant difficulty.

In the bill payment and presentment industry, however, the documents prepared are more typically submitted to a large remittance processing operation, such as those operated by the banking industry. In this arena, thousands of documents are submitted to a single processing location. Upon receiving these individual documents, the remittance processing facility uses automated equipment to remove one or more edges of the mail piece (typically an envelope). The content of the mail piece are then extracted, by hand or mechanically, and then forwarded to automated reading and sorting equipment, such as an OCR or MICR scanner. A familiar example of this operation would be the processing of payments for an individual's credit card account. Without the ability to automate this process, the handling of these documents would be extremely cumbersome and very costly.

Conventionally, self-mailers have not been compatible with automated processing systems and have, therefore, not been an alternative.

The present invention provides a mailer construction that overcomes these limitations by utilizing a unique manufacturing method to incorporate a series of die-cuts on a form so that after folding and sealing, the contents inside the self-mailer can be easily extracted using automated equipment, as with a conventional envelope.

More particularly, the self-mailer construction described herein creates a single- or double-panel inside a carrier, depending on whether a letter-fold (C-fold) or a double parallel fold (Double V-Fold) is utilized. Die-cuts are positioned in such as way as to reduce the size of at least one internal panel to make it free-floating once an envelope slitter or similar device passes across the top edge of the document. Because these panel(s) are narrow-width, they terminate short of the full-width portion of the outside panels and, therefore, are unattached at any point other than the top edge of the sealed document. Accordingly, when the mailer is engaged with an envelope slitter or similar device, the truncated panel becomes free-floating and can be readily removed.

In a presently preferred embodiment, all imaging or personalization is designed to be accomplished on one side of the document, in order to minimize the time required for a computer to print the form. It is to be understood, however, that the document may be imaged on both sides, if needed, and if the printer includes such capabilities.

Thus, the invention may be embodied in an intermediate for a mailer-type business form, comprising: a quadrate sheet of paper having parallel top and bottom edges, parallel first and second side edges perpendicular to the top edge, and first and second faces; and at least first and second fold lines parallel to said top and bottom edges dividing said sheet into at least first, second, and third panels, said first and second panels having substantially a same size and said third panel having a height and width less than said first and second panels.

### BRIEF DESCRIPTION OF THE DRAWINGS

These and other objects and advantages of this invention, will be more completely understood and appreciated by careful study of the following more detailed description of the presently preferred exemplary embodiments of the invention taken in conjunction with the accompanying drawings, in which:

FIG. 1 is a top plan view of a first face of an exemplary intermediate according to the present invention;

FIG. 2 is a plan view of the second face of the intermediate of FIG. 1;

FIG. 3 is a perspective view showing the intermediate of FIGS. 1 and 2 being folded into a mailer-type business form;

FIG. 4 is a perspective view showing a mailer of the type illustrated in FIG. 2 being slitted by an automated slitter;

FIG. 5 is an exploded perspective view showing the removal of a statement or check from the opened envelope according to an exemplary embodiment of the invention;

FIG. 6 is a perspective view showing the opening of the mailer of FIG. 3 by the end user without a slitter;

FIG. 7 is a perspective view showing the removal of a statement or check from the opened envelope of FIG. 6;

FIG. 8 is a top plan view of a first face of an alternate intermediate according the present invention;

FIG. 9 is a plan view of the second face of the intermediate of FIG. 8;

FIG. 10 is a perspective view showing the intermediate of FIGS. 8-9 being folded into a mailer type business form according to a first folding alternative; and

FIG. 11 is a perspective view showing the intermediate of FIGS. 8-9 being folded into a mailer type business form according to a second folding alternative.

### DETAILED DESCRIPTION OF THE INVENTION

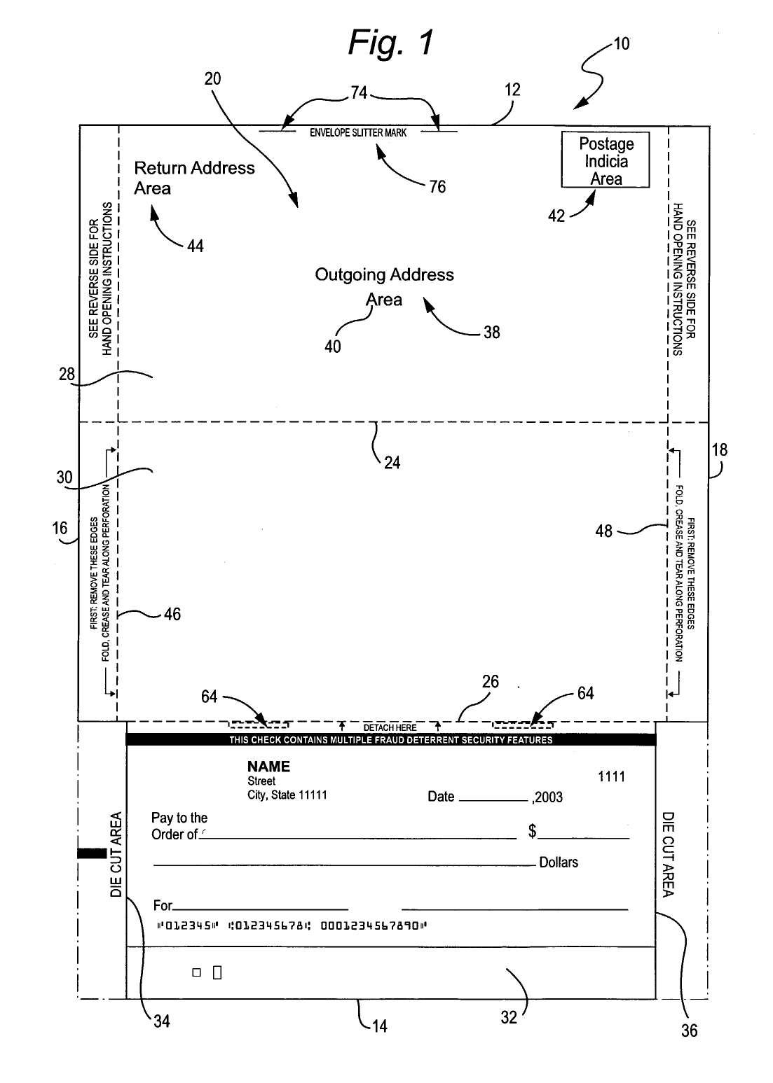

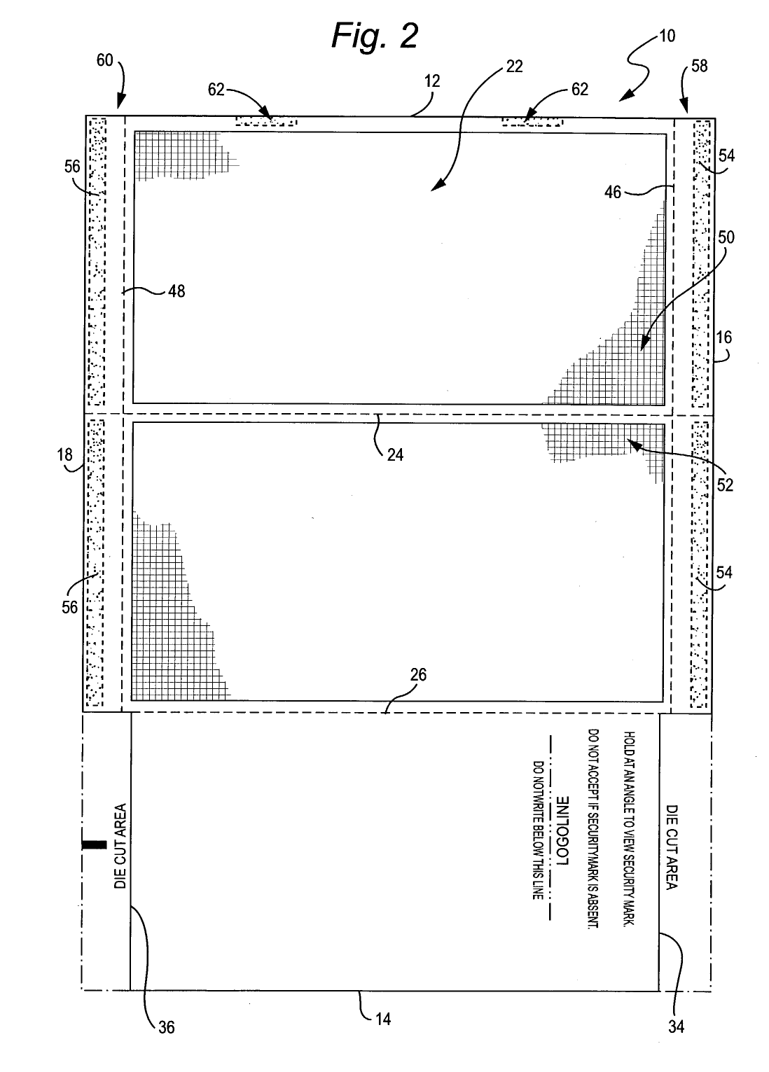

An exemplary intermediate for a mailer-type business form is shown generally by reference number 10 in FIGS. 1 and 2. It includes a quadrate sheet of substantially opaque paper having parallel top and bottom edges 12,14 and parallel first and second side edges 16,18, respectively. The side edges are perpendicular to the top edge. The sheet further defines first and second faces 20,22, FIGS. 1 and 2, respectively. First and second fold lines 24,26 are provided parallel to the top and bottom edges for dividing the sheet into three panels. The first and second panels 28,30 are substantially equal size. According to an exemplary embodiment of the invention, however, the fold lines 24, 26 are disposed and/or the bottom edge 14 of the intermediate is die cut so that the third panel 32 has a width, defined between the second fold line 26 and the bottom edge 14, that is less the width of either of the first and second panels 28, 30, as described in greater detail hereinbelow. Furthermore, the intermediate is die-cut during the manufacturing process, most preferably after printing and before folding, along lines 34, 36, as shown in FIGS. 1 and 2 to truncate the length of the third panel, as also described in greater detail hereinbelow.

With reference to the presently preferred, illustrated embodiment, the first panel 28 is disposed as the top panel of the form, the second panel 30 is disposed as the middle panel and the third panel 32 is disposed as the bottom panel of the form so that the second panel is between the first and third panels. Thus, the first panel is between the top edge 12 and first fold line 24, the second panel is between fold lines 24 and 26 and the third panel is between fold line 26 and bottom edge 14 of the intermediate 10. Fold lines 24,26 may comprise lines of weakness such as perforation lines or die cut lines or may merely be scored or crease lines. In the presently preferred embodiment, where the third panel 32 is adapted to be removed and retained by the end user, fold line 26 is preferably a line of weakness that facilitates separation of the third panel from the second panel. Furthermore, in a presently preferred embodiment, the first and second panels together define the outgoing envelope and, therefore, the first fold line 24 need not be adapted to be severed by the end user. As will become apparent below, the invention is not limited to the described series and orientations of panels, except as required by the appended claims.

The intermediate also includes an outgoing address area 38 on the first face of the first panel. The outgoing address area 38 is of a size and adapted to receive, e.g., a laser printed address or pre-printed address label. The outgoing address area can include indicia corners or other indicator such as a change in texture, tone or color of the paper to facilitate the determination of the proper location of the outgoing address. Such indicators, however, are not critical to the implementation of the invention. Human readable address indicia, as shown only schematically by indicia 40 in FIG. 1 is ultimately provided on the intermediate, for example as it is passed through a printer. Other human or machine readable indicia may also be printed or pre-printed on the first face of the first panel, such as postal address bar coding (not shown), indicia 42 for postal stamp application and/or indicia 44 for the sender's return address. It is to be understood that since the first and second panels together define the out-going envelope, rather than providing the outgoing address, postal and return address indicia on the first face of the first panel, such indicia may be provided on the first face of the second panel 30, upside down relative to the orientation provided in the illustrated embodiment on the first panel 28, without departing from this invention.

In the illustrated embodiment, the third panel 32 is configured as a negotiable instrument, such as a check, and thus advantageously includes human or machine readable indicia preprinted on the first and/or second face of the third panel and variably imaged indicia identifying, for example the payee and the amount paid. In the illustrated and presently preferred embodiment, the mailer is adapted so that all imaging or personalization is accomplished on one side of the document in order to minimize the time required to computer print the form. It is to be understood, however, that the document can be imaged on both sides, if desired.

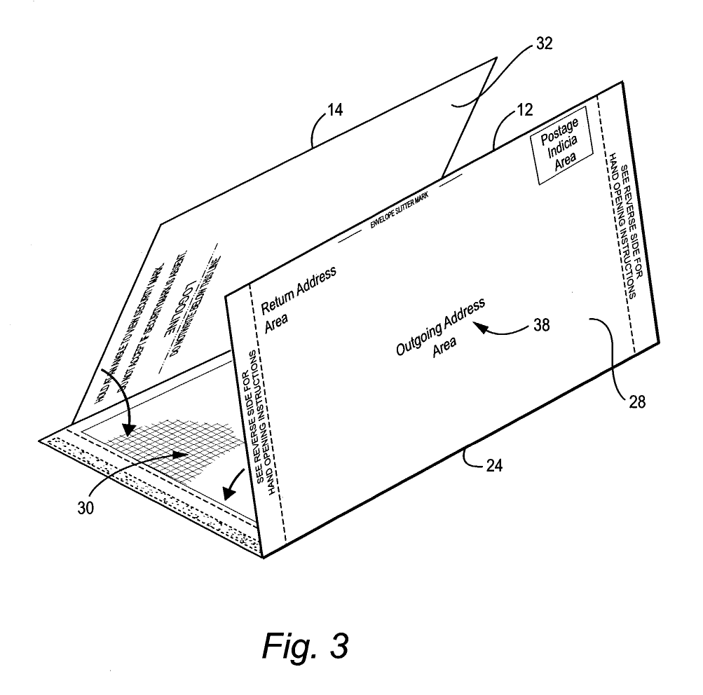

A first line of weakness 46 is formed in the first and second panels 28, 30 parallel to and spaced from the first side edge 16. The first line of weakness defines a tear off strip 58 provided for readily opening one side of a mailer constructed by C-folding the intermediate about fold lines 24,26. A second line of weakness 48 is further formed on the first and second panels parallel to and spaced from the second side edge 18. The second line of weakness defines a tear off strip 60 providing for ready opening of the other side of the mailer constructed by C-folding the intermediate about fold lines 24 and 26 as shown in FIG. 3.

Though not illustrated in detail, where the third panel 32 is defined as a negotiable instrument, such as a check, the intermediate is preferably provided so that the third panel contains multiple fraud deterrent security features. Further, for security and to obscure the check adapted to be contained in the mailer, the second face of the first and second panels preferably are preprinted with security screening as shown at 50 and 52. It is to be understood, however, that the bottom, separable panel need not be a check, but can be printed as an invoice, statement, receipt, or offer informational or commercial document.

The intermediate further comprises a first plurality of adhesive patterns 54, 55 provided along at least some of the edges of the panels for holding the first and second panels together in the outgoing mailer configuration when the sheet is C-folded about fold lines 24,26 as illustrated in FIG. 3. In the illustrated embodiment, the first adhesive patterns 54, 56 include elongated strips provided on the second face 22 of the first and/or second panels in the tear off strips 58, 60 defined by lines of weakness 46, 48.

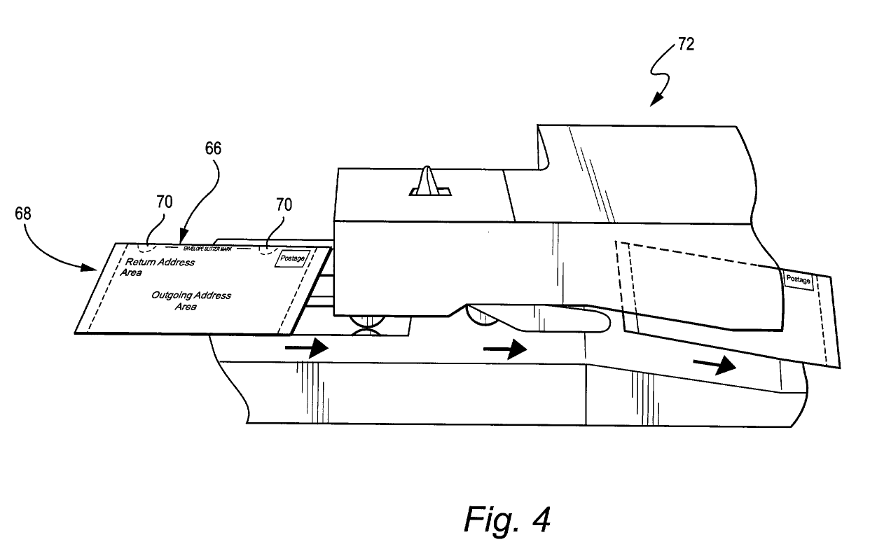

The adhesive patterns preferably also include second adhesive pattern(s) 62, 64 comprised of one or more strips or segments for closing and adhering the intermediate along the top of the C-folded mailer. Thus, an illustrated embodiment, pressure seal cohesive 62 is provided adjacent the top edge of the second face of the first panel and on the first face of the third panel adjacent the second fold line 26. It is to be noted that in the presently preferred embodiment the second adhesive patterns are sized and positioned so as to be disposed in a limited area adjacent the top edge 66 of the folded document/envelope 68 so that the adhesive will be removed when the top edge 66 of the envelope 68 is slitted by an automated slitter. In this regard, because slitters and similar devices remove only small amounts of material (typically 1/16″ to 3/32″ in height), the adhesive 62 64 is desirably placed with a high level of accuracy, within an area about ⅛″ from the respective edges of the panels so that the adhesive applied to the document during manufacture does not substantially extend more than the above-noted typical dimensions below the top edge 66 of the folded form. As an alternative to providing second adhesive areas 62, 64, the top edge 66 of the mailer may be held closed and sealed using a tab or tabs 70 as schematically illustrated in FIG. 4, since this would still accomplish a desired result of freeing the contents defined by the third panel 32 when the document/envelope 68 is passed through a slitter or similar device 72.

Preferably, the adhesive 54, 56, 62, 64 for securing the intermediate in the C-fold mailer configuration is a substantially permanent adhesive that is defined by pressure seal adhesive or cohesive for sealing the mailer upon folding and the application of suitable pressure to the adhesive region. In the alternative, however, the adhesive may be a re-wettable adhesive, or a pressure sensitive adhesive covered by a release strip. Also, rather than continuous elements, the adhesive 54, 56, 62, 64 may be provided as discontinuous elements and/or in a pattern, shape or density other than that shown. Thus, the adhesive areas may take any configuration including dash lines, discontinuous dot configurations and the like. However, it is preferred that the amount and spacing of such adhesive material be at least sufficient to allow the mailer to be processed by U.S. Postal Service automated systems.

As noted above, the intermediate also preferably includes security-screened areas 50, 52 formed on the second face 22 of those portions as the first and second panels 28, 30 that will form the interior of the outgoing envelope. The security screening may be provided by any conventional technique normally prior to the time that the intermediate is transported to the entity or system that will be printing the variable information, such as outgoing address indicia and remittance details.

Although not shown, detachable tractor drive strips may be provided for the intermediate during processing. These strips are conventional for facilitating handling of the intermediate for printing or the like during manufacture of the mailer. These strips are typically provided where the intermediate is in continuous form so that the top and bottom edges 12, 14 are lines of weakness between the longitudinally adjacent intermediates. During normal processing, such strips, (not shown) are slit off at an appropriate stage to define the side edges 16,18.

In constructing the mailer, after the intermediate 10 is detached from the adjacent intermediate continuously printed therewith (if any) and after slitting of any tractor drive strips (if provided), the third panel 32 is die cut along lines 34, 36 as shown. The resultant intermediate is C-folded as illustrated in FIG. 3, (typically by conventional folding equipment) and is then run through a suitable sealing machine (typically conventional equipment, either heat sealing or pressure sealing) for activating the adhesive patterns 54, 56, 62, 64. Typically the intermediate shown in FIGS. 1 and 2 has a length between top and bottom edges 12,14 of less than 12″. In the illustrated embodiment, the first and second panels each have a top to bottom (width) dimension of about 3¼″, whereas the third panel, as defined by die cutting or by the placement of the lines of weakness, has a length of about 3 1/16″. In the illustrated embodiment, the third panel is die cut to define a standard 6″ length check. It is to be understood that if the third panel is adapted to define a statement, receipt, or the like, the die cut length can be varied but is advantageously less than the space or length between lines of weakness 46 and 48.

When the outgoing addressee receives the mailer, the mailer 68 is then comprised of first, second and third plys or panels with the second or bottom face of the first panel 28 in face to face relation with the first or top face of the third panel 32 and the second or bottom face of the second panel 30 in face to face relation with the second or bottom face of the third panel 32. The mailer can be easily opened, as illustrated in FIG. 4, by using automated slitter equipment 72, to slit along the top edge 66 of the mailer. In the illustrated embodiment, the top face of the first panel 28 is preprinted with envelope slitter marks as at 74 and may include preprinted indicia 76 such as “ENVELOPE SLITTER MARK” so that the end user recognizes that the mailer may be opened using automated slitter equipment.

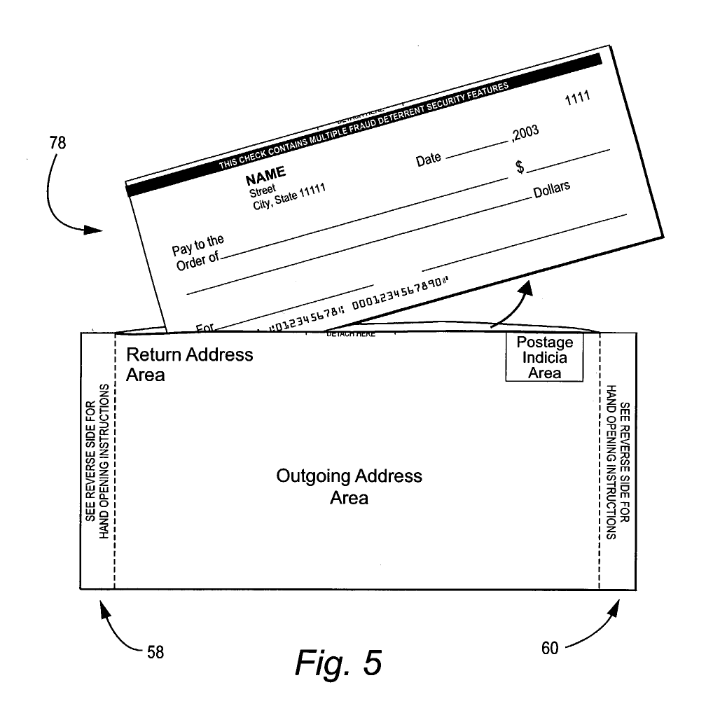

Because the third panel 32 is shorter in length and width than the first and second panels 28, 30, the third panel is free floating inside the mailer 68 except for its attachment to the second panel along line of weakness 26. Once the mailer has been passed through a slitter 72, however, the third panel 32 is severed adjacent the second line of weakness 26 so that the remainder 78 of the third panel is entirely free floating in the mailer and can be removed through the slit open top as illustrated in FIG. 5. When the mailer is slitted using automated slitter equipment 72 as shown in FIG. 4, it is unnecessary to remove the side strips 58, 60 of the envelope.

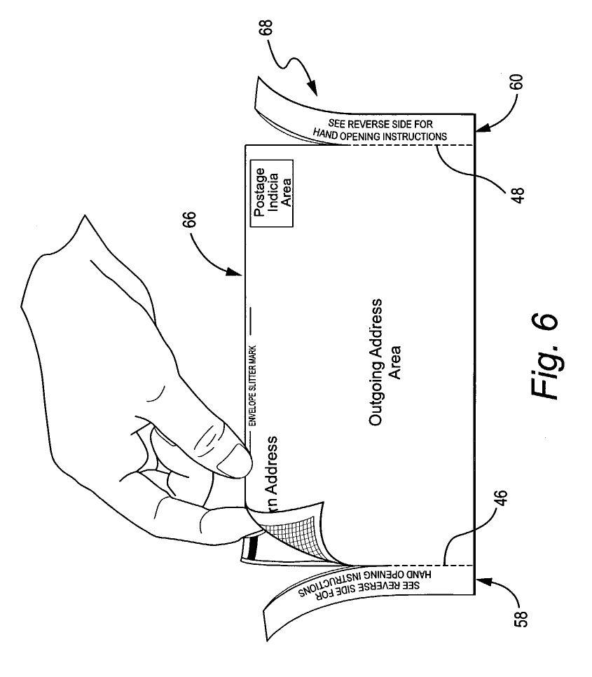

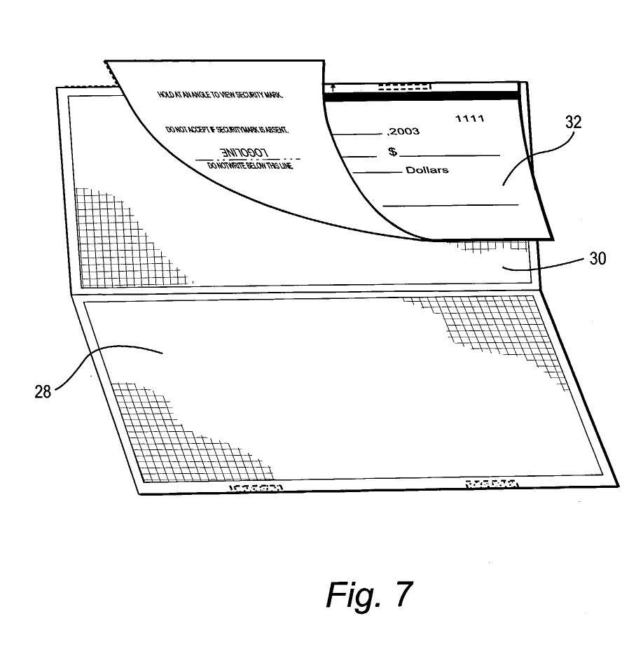

In the event the mailer is received by an end user that does not use automated slitter equipment, the mailer may nevertheless be opened promptly in a conventional manner as illustrated in FIG. 6 by tearing along lines of weakness 46 and 48 and by disrupting the adhesive areas 62, 64 along the top edge 66 of the mailer 68 or disrupting the tabs 70, if provided in lieu of adhesive with an index finger or letter opener. The resultant opened mailer is illustrated in FIG. 7 and the check or other remittance provided as the third panel 32 may be removed from the opened mailer by tearing along the line of weakness 26.

The intermediate and mailer according to the present invention has a number of advantageously results. A major benefit of the design is the ability to open the mailer using conventional slitter equipment 72. A second advantage is the ability to automatically match up the contents with a secure envelope created from the same sheet of paper. Other materials may also be added to the mailer piece by nesting through the use of a equipment similar to a Moore PS-1 or LM-20 Model pressure seal system. Additional advantages include the ability to print variable information on the outgoing mail piece, such as multiple return addresses, individual account numbers, and the like and the ability to include USPS PostNet barcodes on the outgoing mail piece.

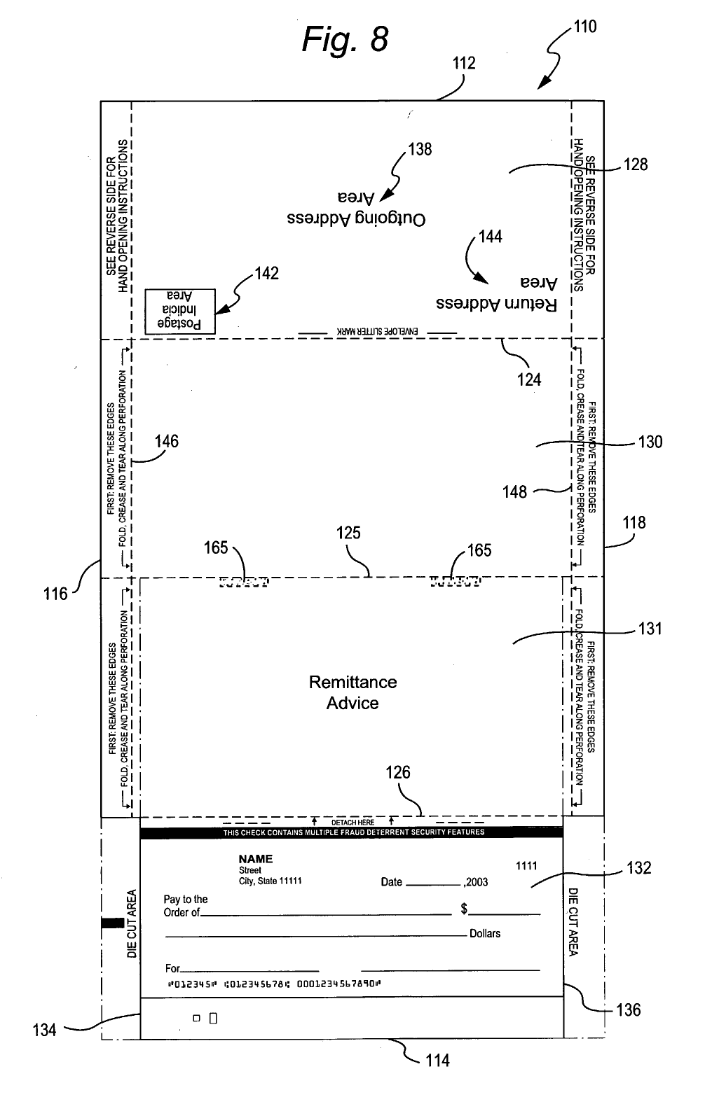

The embodiment described above creates a single panel inside a carrier or letter by C-folding the intermediate. As an alternative to a C-folded mailer, the invention may be adapted to incorporation in a four panel, double V-fold mailer as illustrated in FIGS. 8-11. In this embodiment, several features incorporated in the first embodiment are again provided and the same are similar references are utilized each incremented by 100, but are not described hereinbelow.

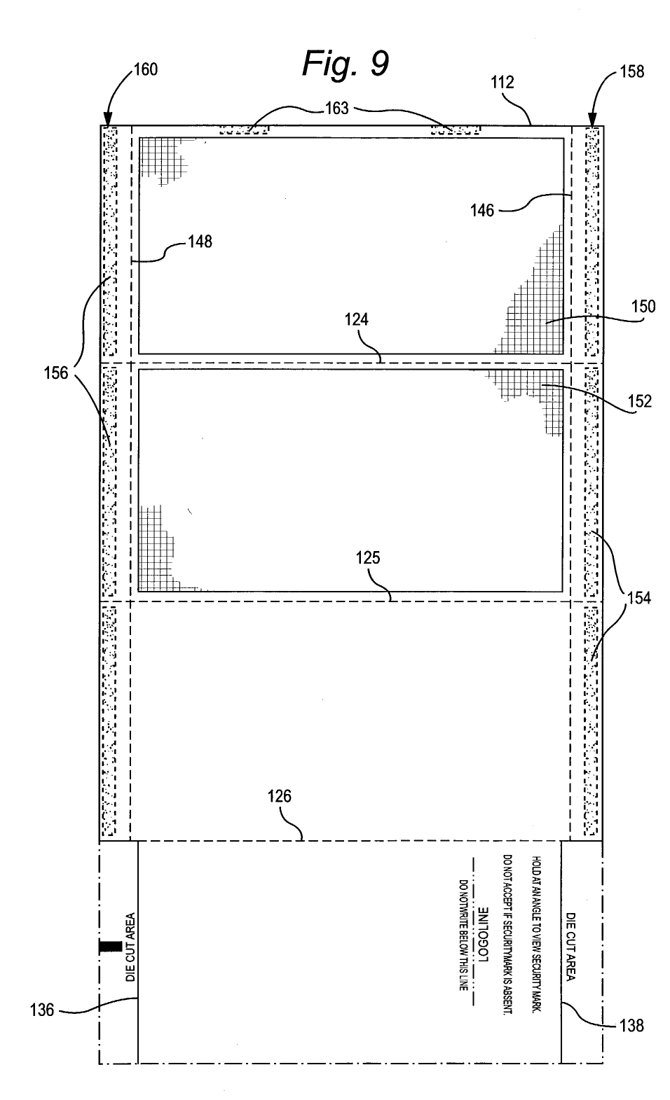

An exemplary alternative intermediate for a mailer-type business form is shown generally by reference number 110 in FIGS. 8 and 9. It includes a quadrate sheet of substantially opaque paper having parallel top and bottom edges 112,114 and parallel first and second side edges 116,118, respectively. The side edges are perpendicular to the top edge. First, second, and third fold lines 124,125,126 are provided parallel to the top and bottom edges for dividing the sheet into four panels. The first, second, and fourth panels 128,130,131 are substantially equal size. According to an exemplary embodiment of the invention, however, the fold lines 124, 125,126 are disposed and/or the bottom edge 114 of the intermediate is die cut so that the third panel 132 has a width, defined between the third fold line 126 and the bottom edge 114, that is less the width of any of the first, second, and fourth panels 128,130,131. The intermediate is die-cut during the manufacturing process, most preferably after printing and before folding, along lines 134, 136, as shown in FIGS. 8 and 9 to truncate the length of the third panel.

With reference to embodiment illustrated in FIGS. 8 and 9, the first panel 128 is disposed as the top panel of the form, the second panel 130 is disposed as the upper middle panel, the third panel 132 is disposed as the bottom panel and the fourth panel 131 is disposed as the lower middle panel of the form. Thus, in the illustrated embodiment, the fourth panel 131 is interposed between said second and third panels 130, 132. Fold lines 124, 125, 126 may comprise lines of weakness such as perforation lines or die cut lines or may merely be scored or crease lines. The invention is not limited however to the described series and orientations of panels.

The intermediate also includes an outgoing address area 138 on the first face of the first panel. The outgoing address area 38 is of a size and adapted to receive, e.g., a laser printed address or pre-printed address label. The outgoing address area can include indicia corners or other indicator such as a change in texture, tone or color of the paper to facilitate the determination of the proper location of the outgoing address. Such indicators, however, are not critical to the implementation of the invention. Human readable address indicia is ultimately provided in area 138 as, for example, it is passed through a printer. Other human or machine readable indicia may also be printed or pre-printed on the first face of the first panel, such as postal address bar coding (not shown), indicia 142 for postal stamp application and/or indicia 144 for the sender's return address. It is to be understood that since the first and second panels together define the out-going envelope, rather than providing the outgoing address, postal and return address indicia on the first face of the first panel, such indicia may be provided on the first face of the second panel 130, upside down relative to the orientation provided in the illustrated embodiment on the first panel 128, without departing from this invention.

As illustrated, the fourth panel 131 may include remittance advice or other pre-printed or variably printed information.

In the illustrated embodiment, the third panel 132 is configured as a negotiable instrument, such as a check, and thus advantageously includes human or machine readable indicia preprinted on the first and/or second face of the third panel and variably imaged indicia identifying, for example the payee and the amount paid. It is to be understood, however, that the bottom, separable panel need not be a check, but can be printed as an invoice, statement, receipt, or offer informational or commercial document.

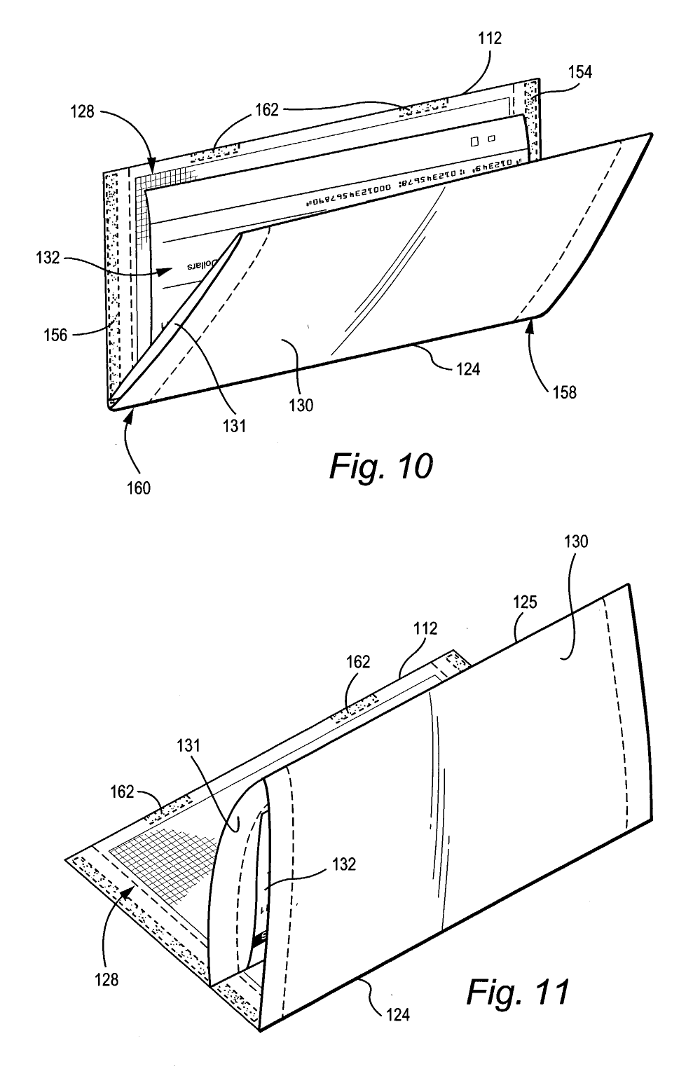

A first line of weakness 146 is formed in the first, second and fourth panels 128, 130, 131, parallel to and spaced from the first side edge 116. The first line of weakness defines a tear off strip 158 provided for readily opening one side of a mailer constructed by folding the intermediate about fold lines 124,125,126. A second line of weakness 148 is further formed on the first and second panels parallel to and spaced from the second side edge 118. The second line of weakness defines a tear off strip 160 providing for ready opening of the other side of the mailer constructed by folding the intermediate about fold lines 124, 125 and 126 as shown in FIGS. 10 and 11.

The intermediate further comprises a first plurality of adhesive patterns 154, 155 provided along at least some of the edges of the panels for holding the first three panels together in the outgoing mailer configuration when the sheet is folded about fold lines 124,125,126 as illustrated in FIG. 10 or 11.

The adhesive patterns preferably also include second adhesive pattern(s) 163, 165 comprised of one or more strips or segments for closing and adhering the intermediate along the bottom of the folded mailer. Thus, an illustrated embodiment, pressure seal cohesive 163, 165 is provided adjacent the top edge of the face of the first panel and on the first face of the fourth panel adjacent the second fold line 125. As an alternative to providing second adhesive areas 163, 165, the bottom edge of the mailer may be held closed and sealed using a tab or tabs, since this would still accomplish a desired result of freeing the contents defined by the third panel 132 when the document/envelope is passed through a slitter or similar device.

Preferably, the adhesive 154, 156, 163, 165 for securing the intermediate in the C-fold mailer configuration is a substantially permanent adhesive that is defined by pressure seal adhesive or cohesive for sealing the mailer upon folding and the application of suitable pressure to the adhesive region. In the alternative, however, the adhesive may be a re-wettable adhesive, or a pressure sensitive adhesive covered by a release strip. Also, rather than continuous elements, the adhesive may be provided as discontinuous elements and/or in a pattern, shape or density other than that shown. Thus, the adhesive areas may take any configuration including dash lines, discontinuous dot configurations and the like. However, it is preferred that the amount and spacing of such adhesive material be at least sufficient to allow the mailer to be processed by U.S. Postal Service automated systems.

In constructing the mailer, after the intermediate 110 is detached from the adjacent intermediate continuously printed therewith (if any) and after slitting of any tractor drive strips (if provided), the third panel 132 is die cut along lines 134, 136 as shown. The resultant intermediate is double V-folded as illustrated in FIG. 10 or V-C folded as illustrated in FIG. 11, (typically by conventional folding equipment) and is then run through a suitable sealing machine (typically conventional equipment, either heat sealing or pressure sealing) for activating the adhesive patterns 154, 156, 163, 165.

When the outgoing addressee receives the mailer, the mailer, the mailer can be easily opened, using automated slitter equipment, to slit along the top edge 66 of the mailer. Because the third panel 132 is shorter in length and width than the first, second, and fourth panels 128, 130, 131, the third panel is free floating inside the mailer except for its attachment to the fourth panel along line of weakness 126. Once the mailer has been passed through a slitter, however, the third panel 132 is severed adjacent the second line of weakness 26 so that the remainder of the third panel is entirely free floating in the mailer and can be removed through the top of the slitted mailer. In the event the mailer is received by an end user that does not use automated slitter equipment, the mailer may nevertheless be opened promptly in a conventional manner.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An intermediate for a mailer-type business form, comprising:
a quadrate sheet of paper having parallel top and bottom edges, parallel first and second side edges perpendicular to the top edge, and first and second faces; and
at least first and second fold lines parallel to said top and bottom edges dividing said sheet into at least first, second, and third panels, said first and second panels having substantially a same size and said third panel having a height and width less than said first and second panels.

2. An intermediate as in claim 1, further comprising an outgoing address area defined on said first face of one of said first and second panels, said outgoing address area being spaced from said first and second side edges.

3. An intermediate as in claim 1, wherein one of said first and second faces of said third panel is printed as a negotiable instrument.

4. An intermediate as in claim 3, wherein said second fold line is disposed between said second and third panels, and said second fold line is a perforated line for facilitating detachment of said third panel from said second panel.

5. An intermediate as in claim 1, further comprising security screening pre-printed on at least one face of at least one of said first and second panels.

6. An intermediate as in claim 1, further comprising a first line of weakness formed in said first and second panels parallel to and spaced from said first side edge; said first line of weakness defining a tear off strip providing for ready opening of a mailer constructed by folding said sheet about said fold lines;
a second line of weakness formed in said first and second panels parallel to and spaced from said second side edge, said second line of weakness defining a tear off strip providing for ready opening of a mailer constructed by folding said sheet about said fold lines; and
first adhesive areas provided at least in said first and second tear off strips and holding said first and second panels together as an outgoing mailer when said sheet is folded about said fold lines.

7. An intermediate as in claim 1, further comprising at least one adhesive area adjacent a top edge of a second face of said first panel and at least one adhesive area along a top edge of a first face of said third panel, whereby when said intermediate is C-folded along said fold lines to form a mailer, said adhesive areas of said first and third panels engage to seal a top edge of said mailer upon application of at least one of heat and pressure thereto.

8. An intermediate as in claim 7, wherein said adhesive areas are substantially limited to an area within about 1/8 inch from the respective edges of the panels.

9. An intermediate as in claim 1, further comprising a fourth panel disposed between said second and third panels, said second fold line being disposed between said second panel and said fourth panel, and a third fold line being disposed between said fourth panel and said third panel.

10. An intermediate as in claim 9, wherein said third fold line is a perforated line for facilitating detachment of said third panel from said fourth panel.

11. An intermediate as in claim 9, wherein one of said first and second faces of said third panel is printed as a negotiable instrument.

12. An intermediate as in claim 9, further comprising at least one adhesive area adjacent a top edge of a second face of said first panel and at least one adhesive area along a top edge of a first face of said fourth panel, whereby when said intermediate is folded along said fold lines to form a mailer, said adhesive areas of said first and fourth panels engage to seal a bottom edge of said mailer upon application of at least one of heat and pressure thereto.

13. An intermediate as in claim 1, C-folded along said fold lines to form a mailer and further comprising at least one adhesive tab for adhering respectively adjacent edges of the first and third panels.
